(19) United States
(12) Patent Application Publication
(10) Pub. No.: US 2009/0314699 A1
(43) Pub. Date: Dec. 24, 2009

(54) Water Purification Apparatus

(75) Inventor: Viljo Jarvenpaa, Kerava (FI)

Correspondence Address: Cozen O''Connor, 250 PARK AVENUE, NEW YORK, NY, 10177, US

(73) Assignee: Wiser Oy, Kerava (FI)

(21) Appl. No.: 11/915,910

(22) PCT Filed: Jun. 8, 2006
(86) PCT No.: PCT/FI2006/000185

§ 371 Date: Jan. 28, 2008

(51) Int. Cl. B01D 21/08; C02F 1/24; C02F 1/52; C02F 9/08

(52) U.S. Cl. 210/151

(57) ABSTRACT

The invention relates to a water purification apparatus comprising a sedimentation basin (10), a flotation basin (20), a flow channel for conveying water containing impurities as flow (A) into the sedimentation basin (10) and means for conveying the purified water out of the water purification apparatus. A flow channel (17) leading out of the sedimentation basin (10) is connected to a mixing channel (21) placed in the flotation basin (20) and containing micro-bubbles, the water in the sedimentation basin (10) which still contains small amounts of impurities being arranged to flow via the flow channel (17) into the mixing channel (21), where the remaining impurities stick to the micro-bubbles in the mixing channel (21) and rise together with the micro-bubbles to the upper surface of the flotation basin (20).

The present invention relates to a water purification apparatus as defined in the preamble of claim 1.

In present-day society, wastewater purification is required. This applies both to wastewater produced in various industrial processes and to wastewater produced by society. In a wastewater purification process, the aim is to bring the impurities into a solid form so that they can be removed from the water. The commonest method, which has been used since ages, is to remove solids by letting these impurity concentrations to settle to the bottom in a suitable basin. From there, the sediment is either scraped away or the water is let out from the basin and the more or less dried and waterless solid material is collected away.

Wastewaters contain various components, such as e.g. tensides, solvents, bases, acids and many other substances, which may disturb both natural bacterial activity and the possibilities of action and properties of the chemicals, eventually leading to a disturbance where either part or all of the impurities are not removed from the water to form flocks, i.e. solid particles, but either remain in a completely dissolved state in the water or form a gelatinous sludge. Such sludge does not settle to the bottom in sedimentation, and neither do very small floccules, which go through.

Due to the above reasoning, there has arisen a demand for further processing or ensuring of sedimentation. In many waterworks, this is already implemented by using flotation, which replaces sedimentation and differs from the latter in that it works in the opposite manner, i.e. so solid material is raised to the surface of the water/liquid. Whereas in sedimentation solid particles are deposited to the bottom of the basin, in flotation solid particles rise to the surface of the basin.

In flotation, solid materials are brought to the surface by small gas microbubbles. These are formed e.g. by a process whereby the gas is first dissolved in pressurized water, most commonly at a pressure of 4-8 bar, whereupon the pressure is relieved, with the result that, according to Henry's law, the dissolved gas is released from the liquid. It depends only on the technique of relieving the pressure and on the method of application how small micro-bubbles can be produced by each method. When these micro-bubbles adhere to solid floccules, particles or droplets of another phase (e.g. oil), these rise together to the surface of the liquid/water, from where these impurities can be collected away as a separate output by a method known in itself. The purified water can be recirculated or discharged into nature or sewers.

In respect of technology and economy, it is important how this flotation is implemented and at what cost this additional ensuring is accomplished, so as to prevent the solid material and sludge from escaping, i.e. from getting through from the sedimentation stage.

The flotation process following sedimentation is generally constructed using separate basins, and therefore such an implementation costs considerable sums of money. A further factor to be considered is the required land area. While conventional sedimentation requires a separate large surface area which is utilized to slow down the flow rate of the water so as to allow the sludge and solid floccules, i.e. flocks to settle to the bottom of the basin, flotation only requires 12 -25% of a corresponding area for raising the same solid material to the surface. Therefore, flotation is by far a more effective solution for purifying water of solid materials than sedimentation. As for price, we can state that a flotation solution only costs fractions of the cost of sedimentation.

The object of the invention is to achieve an improvement to currently known methods and apparatus for purifying wastewaters of impurities contained in them. A specific object of the invention is to create a water purification apparatus that permits a very good wastewater purification result to be achieved at as low investment costs as possible.

The objects of the invention are achieved by a water purification apparatus characterized by the features presented in the characterization part of claim 1.

In the water purification apparatus of the invention, solid material is removed via a two-stage process, wherein water having passed through a biological oxidizing process or a chemical purification process is relieved of solid materials/flocks/sludge in two stages by letting the water settle in a first stage to remove most of its solid material content in a sedimentation basin, i.e. in a so-called primary section, and in a further processing stage any solid material that may remain in the water is flotated immediately, preferably in the same flotation process forming an extension of the sedimentation basin, i.e. in a flotation process in a so-called secondary section, wherein the mainly purified water obtained after the sedimentation is drawn from the upper surface of the outflowing water or from a level close to it through one or more suction pipes into one or more so-called riser pipes/mixing tubes on the other side of a partition, into which pipe are also directed the micro-bubbles produced from the dispersion water. As the micro-bubbles rise in the mixing tube, they stick to the residual flocks and solid materials in the water and thus they are brought together with the water to the surface of the liquid in the flotation section, where the flocks with the micro-bubbles are left on the surface for separate removal and the clean water sinks to the outlet via a partition or outlet located at a lower level than the upper end of the mixing tube.

With the solution of the invention, large economical savings in investments are achieved by converting the downstream end/outer edge of a sedimentation basin into a flotator. This involves converting only a small part, 10% or at most 25%, of the useless downstream end of the sedimentation basin for a flotation function. In most cases, this part in sedimentation only represents a tiny fraction in the separation of solid material, because most of the solid materials and flocks have already settled to the bottom in the upstream end of the sedimentation basin. As the water in the downstream end thus only contains a small amount of flocks, flotation can in any case fully cope with these. When sedimentation works and the flocks are well formed, the upstream end of the sedimentation stage is completely sufficient for the function in question. On the other hand, if flocculation has only worked partially or the process is otherwise incomplete, there is a risk of escape of solid material. As the downstream end/outer edge of the sedimentation stage according to the present invention contains a flotator, escape of solid material is prevented. Therefore, the invention can be regarded as a combined sedimentor-flotator, which is the same size as the former sedimentor but which in respect of efficiency is an absolutely superior solution for ensuring the purification of water. It is also to be noted that, via sedimentation, often most of the solid material can be deposited, i.e. sedimented from the water and thus only a small load remains to be treated by flotation, which permits a very good water purification result to be obtained.

In respect of purchase price, the solution of the invention is considerably more economical than a sedimentor and a flotator implemented separately. To the solution described, it is also possible to add features like additional flocculating chemicalization and e.g. required polymer supplies.

The invention will now be described in more detail with reference to a few preferred embodiments of the invention presented in the figures of the attached drawings, to which the invention is however not exclusively limited.

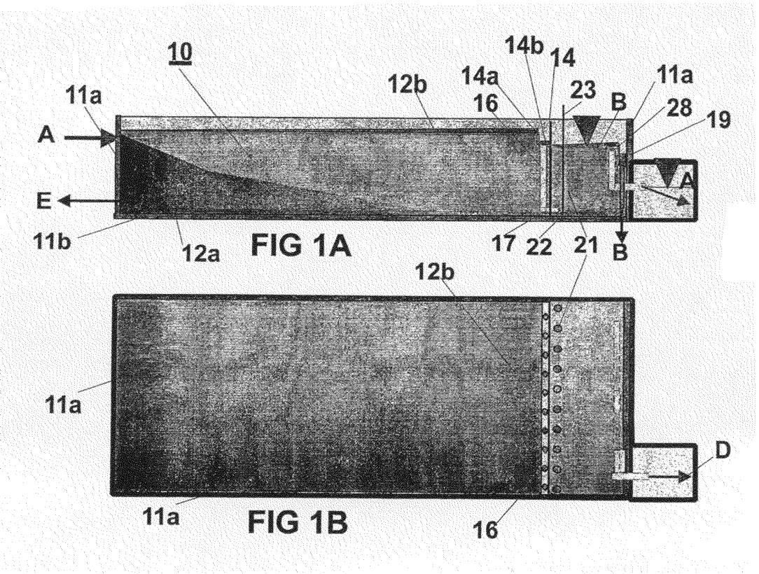

FIG. 1A presents a diagrammatic cross-sectional view of a preferred embodiment of the water purification apparatus of the invention.

FIG. 1B presents a cross-sectional top view of the water purification apparatus in FIG. 1A.

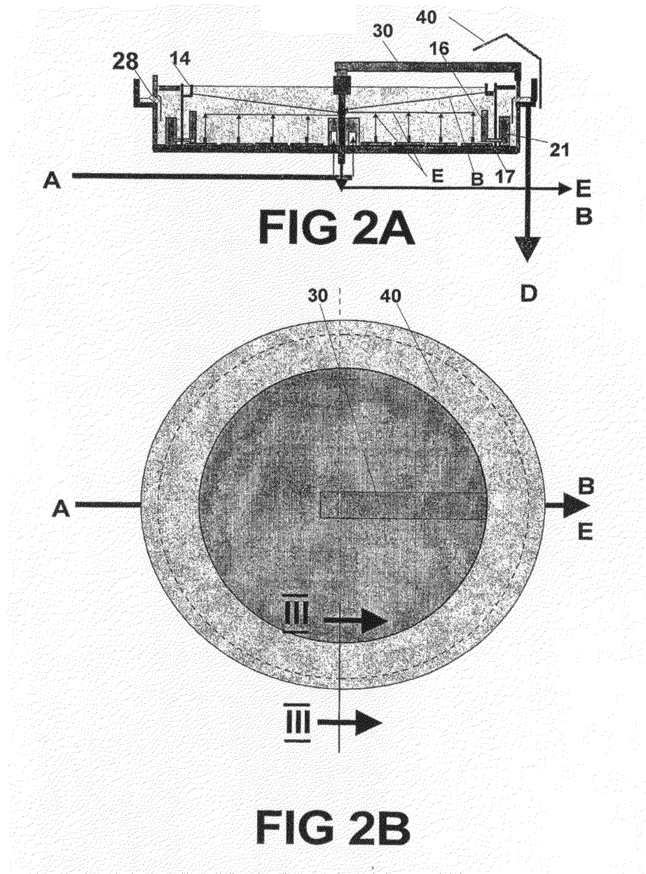

FIG. 2A presents a diagrammatic cross-sectional view of a second preferred embodiment of the water purification apparatus of the invention.

FIG. 2B presents a cross-sectional top view of the water purification apparatus in FIG. 2A.

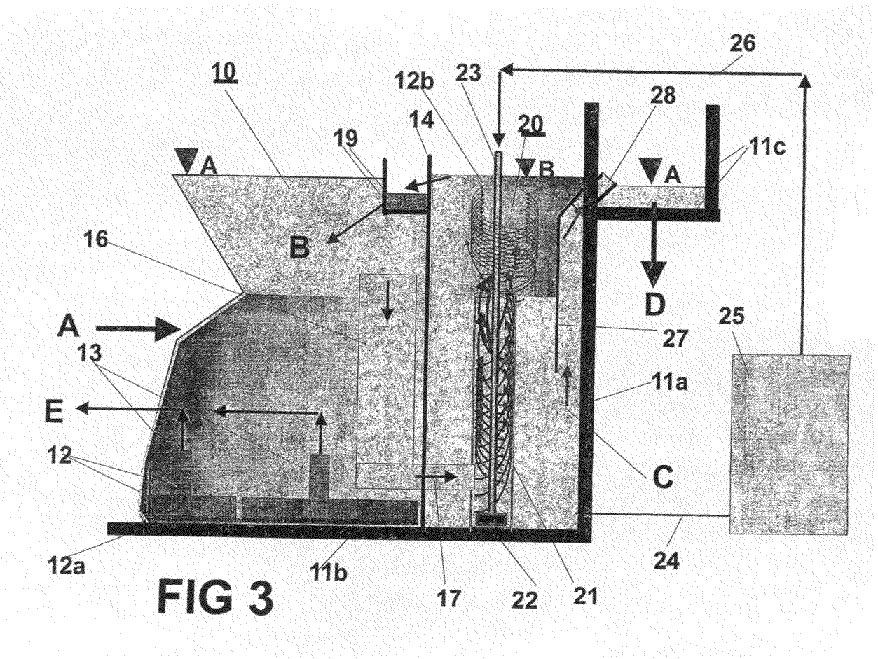

FIG. 3 presents a section along line III-III in FIG. 2B.

According to FIGS. 1A and 1B, a sedimenting water flow A with a flock content comes from a biological or equivalent purification treatment into a sedimentation basin 10, which is formed by walls 11a and 11b and which can be called a primary section. In the sedimentation basin 10, the main proportion of the sludge and flocks settles to the bottom of the basin 10, as illustrated in FIG. 1A by sludge 12a. In the sedimentation basin 10, a proportion of the flocks, and especially oil, may rise to the surface and form a scum 12b. In practice, the apparatus comprises collectors 12 constructed for both of these as illustrated in FIG. 3, and from which e.g. the sediment 12a exits via channels 13 as flow E. Often both the sediment 12a and the surface sludge 12b are combined to form flow E, but they can also be kept separate, especially if the surface sludge 12b consists of oil.

During sedimentation, a light portion of the sludge 12a carried into the sedimentation basin 10 with the water flow A may rise to the surface of the sedimentation basin 10. This is what happens especially to oil, which must absolutely be removed. This can be implemented according to the invention by flotating e.g. the oil to the surface and away from the exiting water in a flotation basin 20, which can be called a secondary section. In a preferred embodiment of the invention, oil flows from the upper surface of the sedimentation basin 10 into a suction channel 16 and further along a flow channel 17 into a mixing channel 21, as illustrated in FIG A.

In a preferred embodiment of the invention, as illustrated in FIG. 1A, the outflowing water, which still contains small floccules, particles and flocks that do not sink to the bottom as well as phases having risen to the surface, such as oil 12b, is passed directly over an edge flute 14a into a flute 14b formed by the edge flute 14a and a partition 14, from where the water together with the remaining impurities flows via the suction channel 16 through the partition 14 via a conduit 17 into the mixing channel 21 of the flotation basin 20. The suction tube 16 can take the water flowing out of the primary stage either from the surface of the water, as illustrated in FIG. 1A, or from a level close to the surface or from a desired level from the sedimentation basin 10, as illustrated in FIG. 3. The bottom of the mixing channel 21 is provided with a nozzle 22, through which the pressurized dispersion water (usually 4-8 bar) coming to the nozzle 22 from the pipe 23 directed into the mixing channel 21 is relieved to normal pressure conditions in the mixing channel 21. The dispersion water is preferably taken as part of the water purified by flotation via a flow channel 24 for gas dissolution into a technical unit 25 known in itself, where the gas is dissolved according to Henry's law into pressurized water and passed via a flow channel 26 into pipe 23.

In the mixing channel 21, flocks and the micro-bubbles produced by the nozzle 22 combine and flow together with the water along the mixing channel 21 to the water surface, where a scum-like sludge is formed on the surface of the water at surface level ▾B, from where the surface sludge is passed in a manner known in itself, e.g. according to in FIG. 1A, into the flute 19, in this case behind the partition 14 and from there further as flow B, as shown in FIG. 2, to the outlet, where the sediment 12a is also taken via collectors 12 and channels 13 as flow E. One method is to utilize a collecting bridge 30 revolving in the sedimentation basin 10 and provided with drags which can collect the surface scum into the flute 19 or otherwise in a manner known in itself so as to form flow B.

If the flotation is implemented e.g. in circular basins as illustrated in FIG. 2, the flotation basin 20 can be protected against weather by a canopy 40.

In the embodiment illustrated in FIG. 3, in the flotation the water purified of flocks and other residual impurities exits from the flotation basin 20 from below upwards as flow C through partition 27 and channels 28 into a water flume formed by walls 11a and 11c and from there further as flow D. As can be seen from FIGS. 1A and 1B, the surface ▾A of the outflow D is at a considerably lower level than the water in the flotation basin 20, and consequently the water surface in the flotation basin 20 can also be kept lower than the water surface in the sedimentation basin 10. In this way, e.g. any oil 12b on the surface of the water in the sedimentation basin 10 is caused to flow into the flute 14b.

As for purchase price, the solution of the invention is considerably more advantageous than a sedimentor and a flotator implemented separately. In the solution described above, it is possible to apply e.g. additional flocculating chemicalization and polymer supplies.

In the foregoing, only a few preferred embodiments of the invention have been described, and it is obvious to a person skilled in the art that numbers modifications can be made in them within the scope of the inventive concept presented in the claims below.

1. Water purification apparatus, comprising a sedimentation basin (10), a flotation basin (20), a flow channel for conveying water containing impurities as a flow (A) into the aforesaid sedimentation basin (10) and means for conveying the purified water out of the aforesaid water purification apparatus, characterized in that a flow channel (17) leading out of the aforesaid sedimentation basin (10) is connected to a mixing channel (21) placed in the aforesaid flotation basin (20) and containing micro-bubbles, the water in the sedimentation basin (10) which still contains small amounts of impurities being arranged to flow via the aforesaid flow channel (17) into the aforesaid mixing channel (21), where the remaining impurities stick to the micro-bubbles in the aforesaid mixing channel (21) and rise together with the micro-bubbles to the upper surface of the aforesaid flotation basin (20).

2. Water purification apparatus according to claim 1, wherein the flotation basin (20) has been formed from the downstream end of the sedimentation basin (10) by means of a partition (14).

3. Water purification apparatus according to claim 1, wherein it comprises a tubular conduit (23) placed inside the mixing channel (21) for conveying pressurized dispersion water into the mixing channel (21).

4. Water purification apparatus according to claim 3, wherein the tubular conduit (23) is provided with a nozzle (22) for relieving the pressurized dispersion water to normal pressure in order to produce micro-bubbles.

5. Water purification apparatus according to claim 1, wherein the sedimentation basin (10) is provided with a suction channel (16) connected to the aforesaid flow channel (17).

6. Water purification apparatus according to claim 1, wherein the sedimentation basin (10) is provided with a flute (14b) for conveying the purified water out of the sedimentation basin (10).

7. Water purification apparatus according to claim 6, wherein the aforesaid flute (14b) is formed by the edge flute (14a) and the partition (14) in the sedimentation basin (10).

8. Water purification apparatus according to claim 1, wherein the flotation basin (20) is provided with a flute (19) for conveying the surface scum out of the said flotation basin (20) as flow (B).

9. Water purification apparatus according to claim 1, wherein the flotation basin (20) is provided with a flow channel (28) for conveying the purified water out of the said flotation basin (20) as flow (D).

10. Water purification apparatus according to claim 1, wherein the aforesaid sedimentation basin (10) and the aforesaid flotation basin (20) are of a circular shape, that the aforesaid sedimentation basin (10) has a collecting bridge (30) provided with drags, and that the flotation basin (20) is provided with a canopy (40).
